(19) United States
(12) Patent Application Publication
(10) Pub. No.: US 2011/0261571 A1
(43) Pub. Date: Oct. 27, 2011

(54) HEAT DISSIPATION ASSISTING APPARATUS FOR LAMP

(75) Inventor: Yu-Chi Wu, Taipei (TW)

(73) Assignee: ADVANCED-CONNECTEK INC., Taipei (TW)

(21) Appl. No.: 13/089,590

(22) Filed: Apr. 19, 2011

(30) Foreign Application Priority Data
Apr. 27, 2010 (TW) 099207692

(51) Int. Cl. F21V 29/00

(52) U.S. Cl. 362/373

(57) ABSTRACT

The invention discloses a heat dissipation assisting apparatus for lamp to form a flow channel space between the heat dissipation lamp holder and the shell. When the lamp is in operation, heat generated by the lamp is assimilated by the heat dissipation lamp holder, and gas in the flow channel space is heated by the heat assimilated to the heat dissipation lamp holder. Thus, the gas heated would flow in the flow channel space, and form convection with gas in the outside environment to dissipate heat outside, and heat insulation of the shell may prevent a user from being burned. The heat dissipation lamp holder and the shell can be detachable to allow convenient cleaning of dust in the space therebetween, thus preventing from deterioration of heat dissipation efficiency.

### FIELD OF THE INVENTION

The present invention relates to a heat dissipation assisting apparatus for lamp, and particularly to a heat dissipation assisting apparatus for lamp generating heat convection in operation.

### BACKGROUND

A light emitting diodes (LED) is a solid light emitting device made of semiconductor materials, which generally uses chemical elements in the III-V groups (such as GaP or GaAs), and emits light by transforming electricity power to light. That is, electricity is supplied to semiconductor compound, and by combination of electrons and electron holes, excessive energy is released in the form of light to perform cold light emitting. The life span of LEDs can be over 100 thousand hours. LEDs are known for no idling time, fast responsive speed, small volume, energy saving, sustaining to shock, low pollution, fit to mass production, high reliability, and easy to be made to tiny or array-type elements according to application requirements. However, LEDs utilize solid light emission, which means the chips are supplied with electricity to generate excessive energy (light) by quantum excited recovery, and the light energy in the chips cannot fully transfer to the outside environment in light emission. The energy not transferred is thus assimilated by the chips and the packages to generate heat. Generally, transformation efficiency of a LED is about 10%-30%, which means 1 W of electricity generates light equivalent to less than 0.2 W of energy, and other part of energy becomes heat. Without heat dissipation, the heat accumulated in the chips would deteriorate the efficiency and life span of the chips. Thus, to utilize LEDs in the light emitting devices, there is a need to solve the heat dissipation problem. Referring to FIG. 1, which shows a schematic view of a conventional LED lamp device. In the figure, a LED lamp 10 is provided with fins 12 on its surface to increase the surface areas and to increase heat dissipation efficiency. However, practical application shows that the effect is not significant in a windless environment. In addition, most light emitting devices are provided at the corner or on the ceiling, which are places lack of consistent air flow. Moreover, temperature on the heat dissipation surface is typically higher than the range where human body sustains, and it is possible that a user may be burned by touching the heat dissipation surface.

In response to the problems of the conventional arts, with research and practical experience, the inventor provides a heat dissipation assisting apparatus for lamp to change the above-mentioned defects.

### SUMMARY OF THE INVENTION

In view of the problems of the conventional arts, an objective of the present invention is to provide a heat dissipation assisting apparatus for lamp that generates heat convection in the operation of the heat dissipation assisting apparatus for lamp in order to avoid overheat.

To achieve the foregoing objectives of the invention, the invention provides a heat dissipation assisting apparatus for lamp, which comprises a power connecting portion, a heat dissipation lamp holder, a light emitting module and a shell. The power connecting portion is used to connect a power source to provide electricity power. The heat dissipation lamp holder is made of a heat conductive material, and the power connecting portion is disposed at one side of the heat dissipation lamp holder. The light emitting module is disposed at the other side of the heat dissipation lamp holder, and is electrically connected to the power connecting portion. The shell is made of a heat insulation material and is disposed around the heat dissipation lamp holder forming a flow channel space between the heat dissipation lamp holder and the shell, and the flow channel space is connected to outside environment. The light emitting module comprises at least one LED chip, and heat generated by the light emitting module in operation is assimilated by the heat dissipation lamp holder, and gas in the flow channel space is heated to a high temperature by the heat assimilated to the heat dissipation lamp holder to create a temperature difference between the gas in the flow channel space and gas in the outside environment to generate convection.

The heat dissipation lamp holder and the shell respectively can have a blocking portion and a corresponding clip portion, and can be detachable.

As disclosed above, the heat dissipation assisting apparatus for lamp of the present invention has one or more advantages as follows:

(1) The present invention generates convection naturally without consuming excessive power, and increases heat dissipation efficiency, thus avoiding overheat of the LED lamp.

(2) The heat dissipation lamp holder and the shell in the present invention are detachable, and when the shell is detached from the heat dissipation lamp holder, a user can clean the surface of the heat dissipation lamp holder and the inner surface of the shell to maintain the cleanness of the flow channel space and to extend the life span of the LED lamp.

(3) The shell of the present invention is made of heat insulation materials to prevent a user from directly touching the heat dissipation lamp holder and being burned.

To improve understanding of the invention, the techniques employed by the present invention to achieve the foregoing objectives, characteristics and effects thereof are described hereinafter by way of examples with reference to the accompanying drawings.

### BRIEF DESCRIPTION OF THE DRAWINGS

FIG. 1 is a schematic view of a conventional LED lamp;

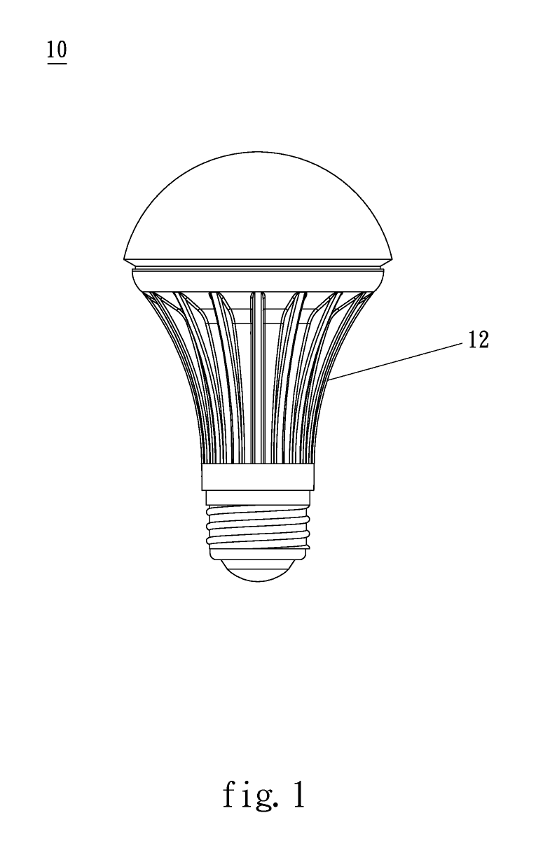

FIG. 2 is a dissembled view of the first embodiment of the present invention;

FIG. 3 is a schematic view of assembly of the first embodiment of the present invention;

FIG. 4 is a cross-sectional view along the line A-A′ in FIG. 3;

FIG. 5 is a cross-sectional view along the line B-B′ in FIG. 3;

FIG. 6 is a dissembled view of the second embodiment of the present invention;

FIG. 7 is a schematic view of assembly of the second embodiment of the present invention;

FIG. 8 is a cross-sectional view along the line C-C′ in FIG. 7; and

FIG. 9 is a cross-sectional view along the line D-D′ in FIG. 7.

### DETAILED DESCRIPTION OF THE INVENTION

The techniques employed by the present invention to achieve the foregoing objectives, characteristics and effects thereof are described hereinafter by way of examples with reference to the accompanying drawings. For better understanding, the same elements in different embodiments are referred to and denoted by the same numerals.

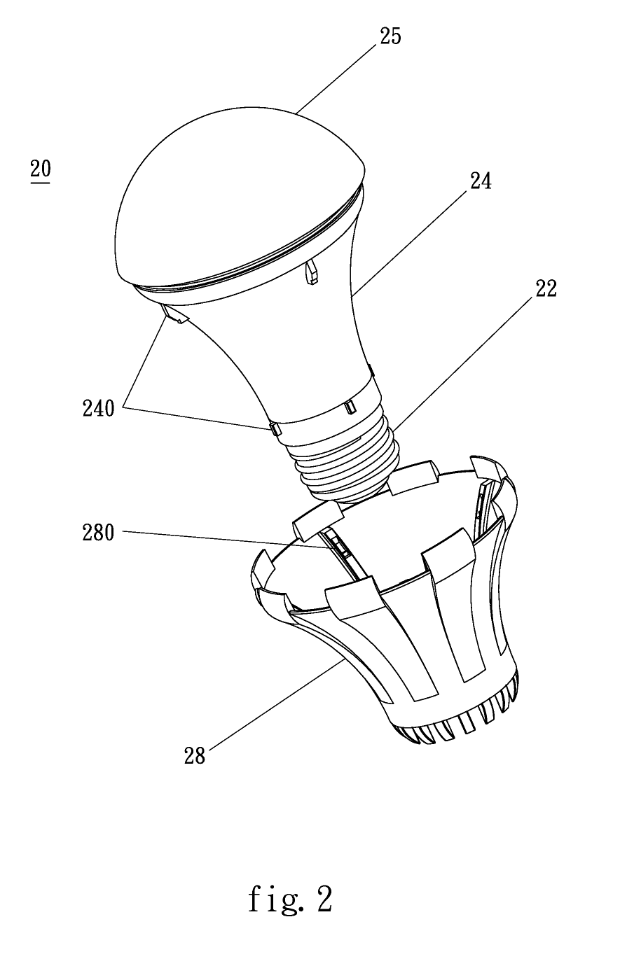

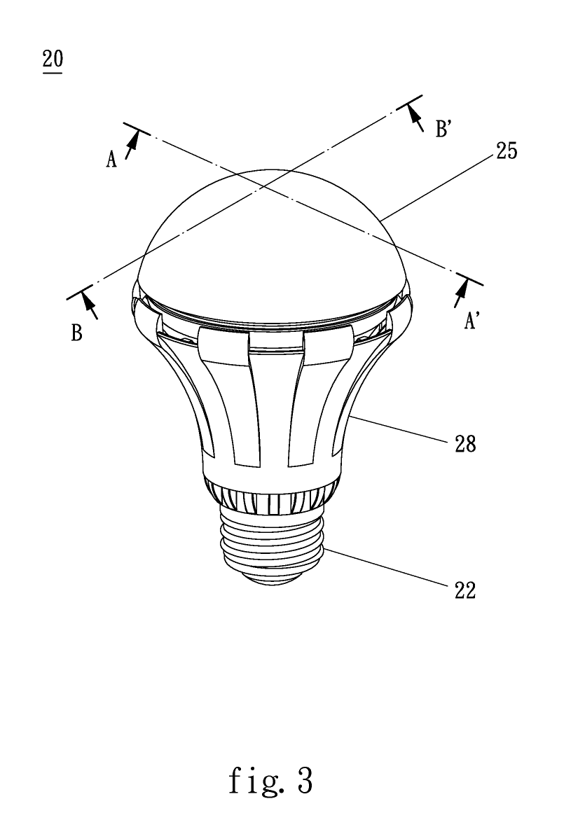

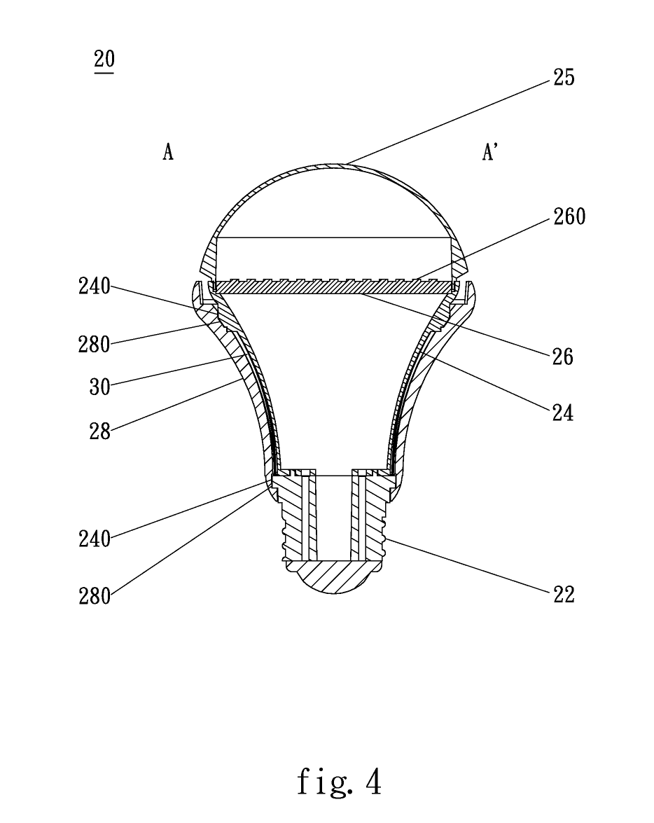

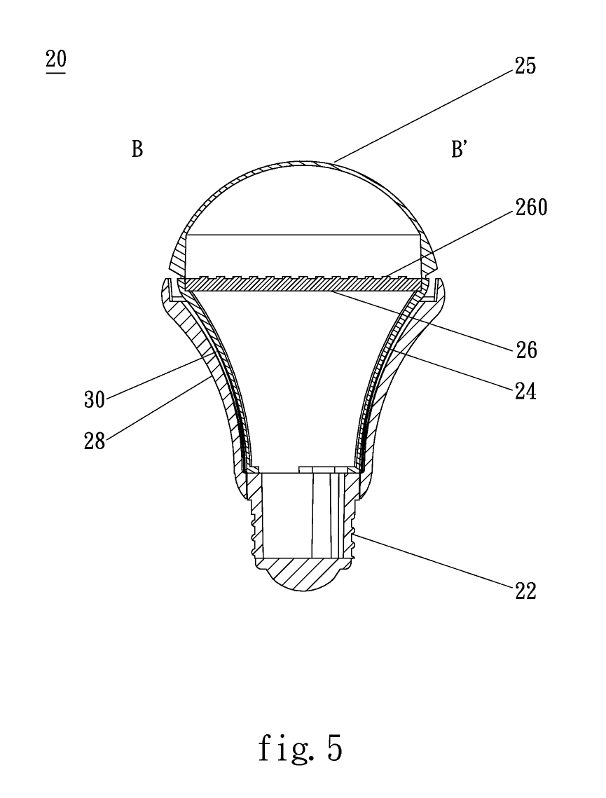

Referring to FIG. 2 to FIG. 5, FIG. 2 is a dissembled view of the first embodiment of the present invention, FIG. 3 is a schematic view of assembly of the first embodiment of the present invention, FIG. 4 is a cross-sectional view along the line A-A′ in FIG. 3, and FIG. 5 is a cross-sectional view along the line B-B′ in FIG. 3. The heat dissipation assisting apparatus for lamp 20 in the figures is mainly used in a bulb-type lamp, which comprises a power connecting portion 22, a heat dissipation lamp holder 24, a light emitting module 26, and a shell 28.

The power connecting portion 22 is used to connect a power source to provide electricity power needed for the heat dissipation assisting apparatus for lamp 20. The heat dissipation lamp holder 24 is made of a heat conductive material, and the power connecting portion 22 is disposed at one side of the heat dissipation lamp holder 24. The heat dissipation lamp holder 24 has a blocking portion 240 on its outer surface. The light emitting module 26 is disposed at the other side of the heat dissipation lamp holder 24, and is electrically connected to the power connecting portion 22 to provide electricity to the LED chip 260 on the light emitting module 26. A transparent cover 25 is disposed at the other side of the heat dissipation lamp holder 24 to cover the light emitting module 26.

The shell 28 is made of a heat insulation material and is disposed around the heat dissipation lamp holder 24. The shell 28 has a clip portion 280 on its inner surface, and when the shell 28 fits to the heat dissipation lamp holder 24, the clip portion 280 corresponds to the blocking portion 240 to form a combination, and according to the embodiment, the shell 28 is prevented from rotating around the heat dissipation lamp holder 24 by the combination. When the heat dissipation lamp holder 24 and the shell 28 are combined, a flow channel space 30 with a gap distance of about 6 mm is formed between the heat dissipation lamp holder 24 and the shell 28, and the flow channel space 30 is connected to outside environment.

When a user activates the light emitting module 26 is activated for operation, heat generated by the light emitting module 26 is assimilated by the heat dissipation lamp holder 24, and gas in the flow channel space 30 is heated to a high temperature and low gas density by the heat assimilated to the heat dissipation lamp holder 24 to create a temperature difference and density difference between the gas in the flow channel space 30 and gas in the outside environment to generate heat convection. Thus, heat from the heat dissipation lamp holder 24 is dissipated to the outside environment.

The heat dissipation lamp holder 24 and the shell 28 are not fixed and are detachable. Thus, when the flow channel space 30 is piled with dust and the heat dissipation efficiency is lowered, the user may detach the shell 28 from the heat dissipation lamp holder 24 and easily clean the outer surface of the heat dissipation lamp holder 24 and the inner surface of the shell 28 to maintain effective heat dissipation efficiency and to indirectly increase the life span of the LED chip 260. The shell 28 is made of a heat insulation material and disposed around the heat dissipation lamp holder 24, and the user would be prevented from directly touching the heat dissipation lamp holder 24 and get burned, thus increasing safety of usage.

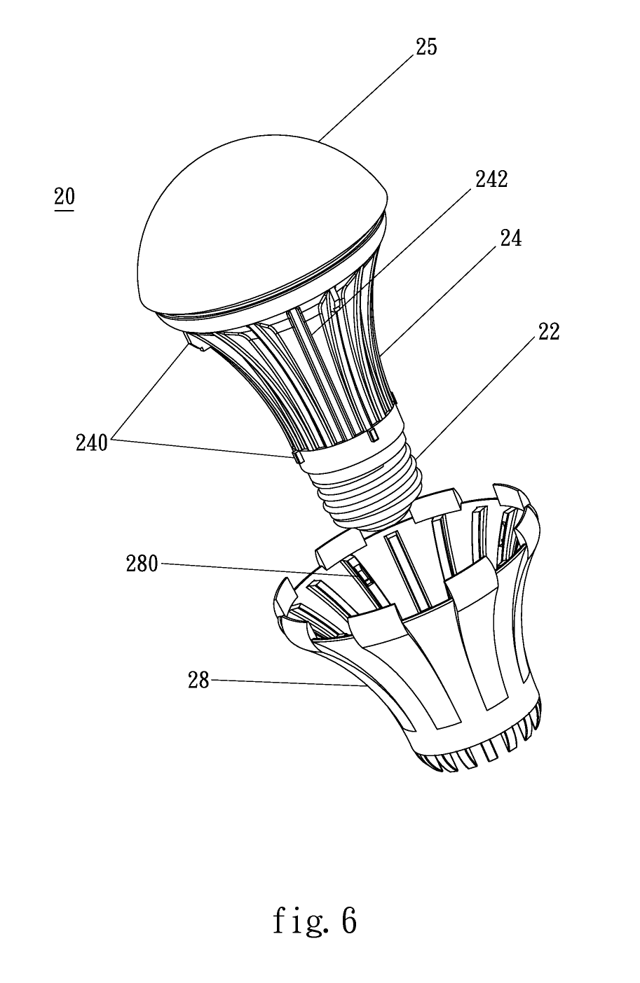

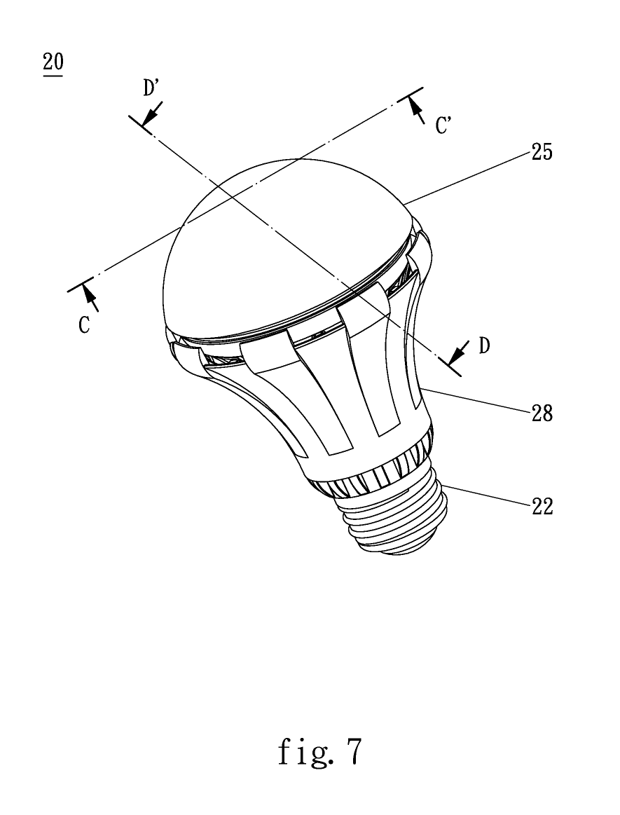

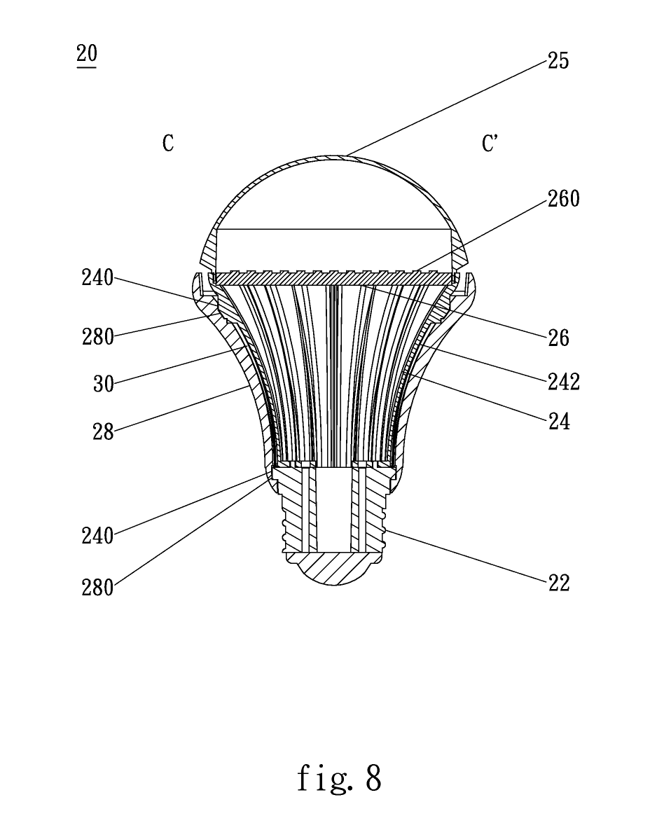

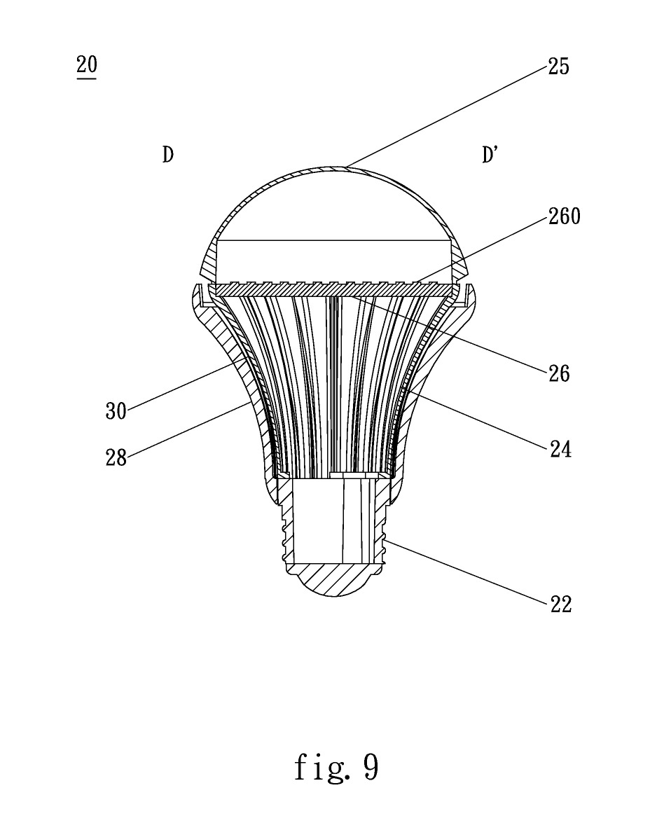

Referring to FIG. 6 to FIG. 9, FIG. 6 is a dissembled view of the second embodiment of the present invention, FIG. 7 is a schematic view of assembly of the second embodiment of the present invention, FIG. 8 is a cross-sectional view along the line C-C′ in FIG. 7, and FIG. 9 is a cross-sectional view along the line D-D′ in FIG. 7. The heat dissipation assisting apparatus for lamp 20 in the figures is mainly used in a bulb-type lamp, which comprises a power connecting portion 22, a heat dissipation lamp holder 24, a light emitting module 26, and a shell 28.

The power connecting portion 22 is used to connect a power source to provide electricity power needed for the heat dissipation assisting apparatus for lamp 20. The heat dissipation lamp holder 24 is made of a heat conductive material, and the power connecting portion 22 is disposed at one side of the heat dissipation lamp holder 24. The heat dissipation lamp holder 24 has a blocking portion 240 on its outer surface, and a plurality of extension members 242 is disposed on its outer surface to increase surface area of heat dissipation. The light emitting module 26 is disposed at the other side of the heat dissipation lamp holder 24, and is electrically connected to the power connecting portion 22 to provide electricity to the LED chip 260 on the light emitting module 26. A transparent cover 25 is disposed at the other side of the heat dissipation lamp holder 24 to cover the light emitting module 26.

The shell 28 is made of a heat insulation material and is disposed around the heat dissipation lamp holder 24. The shell 28 has a clip portion 280 on its inner surface, and when the shell 28 fits to the heat dissipation lamp holder 24, the clip portion 280 corresponds to the blocking portion 240 to form a combination, and according to the embodiment, the shell 28 is prevented from rotating around the heat dissipation lamp holder 24 by the combination. When the heat dissipation lamp holder 24 and the shell 28 are combined, a flow channel space 30 with a gap distance of about 6 mm is formed between the heat dissipation lamp holder 24 and the shell 28, and the flow channel space 30 is connected to outside environment.

When a user activates the light emitting module 26 is activated for operation, heat generated by the light emitting module 26 is assimilated by the heat dissipation lamp holder 24, and gas in the flow channel space 30 is heated to a high temperature and low gas density by the heat assimilated to the heat dissipation lamp holder 24 to create a temperature difference and density difference between the gas in the flow channel space 30 and gas in the outside environment to generate heat convection. Thus, heat from the heat dissipation lamp holder 24 is dissipated to the outside environment.

The heat dissipation lamp holder 24 and the shell 28 are not fixed and are detachable. Thus, when the flow channel space 30 is piled with dust and the heat dissipation efficiency is lowered, the user may detach the shell 28 from the heat dissipation lamp holder 24 and easily clean the outer surface of the heat dissipation lamp holder 24 and the inner surface of the shell 28 to maintain effective heat dissipation efficiency and to indirectly increase the life span of the LED chip 260. The shell 28 is made of a heat insulation material and disposed around the heat dissipation lamp holder 24, and the user would be prevented from directly touching the heat dissipation lamp holder 24 and get burned, thus increasing safety of usage.

The preferred embodiments of the present invention have been disclosed in the examples to show the applicable value in the related industry. However, the examples should not be construed as a limitation on the actual applicable scope of the invention, and as such, all modifications and alterations without departing from the spirits of the invention and appended claims shall remain within the protected scope and claims of the invention.

What is claimed is:

1. A heat dissipation assisting apparatus for lamp used in a bulb-type lamp, comprising:
a power connecting portion to connect a power source;
a heat dissipation lamp holder made of a heat conductive material, the power connecting portion being disposed at one side of the heat dissipation lamp holder;
a light emitting module disposed at the other side of the heat dissipation lamp holder, and electrically connected to the power connecting portion; and
a shell made of a heat insulation material and disposed around the heat dissipation lamp holder forming a flow channel space between the heat dissipation lamp holder and the shell, the flow channel space connected to outside environment;
wherein heat generated by the light emitting module in operation is assimilated by the heat dissipation lamp holder, and gas in the flow channel space is heated to a high temperature by the heat assimilated to the heat dissipation lamp holder to create a temperature difference between the gas in the flow channel space and gas in the outside environment to generate convection.

2. The heat dissipation assisting apparatus for lamp as claimed in claim 1, wherein the heat dissipation lamp holder and the shell respectively have a blocking portion and a corresponding clip portion.

3. The heat dissipation assisting apparatus for lamp as claimed in claim 2, wherein the heat dissipation lamp holder and the shell are detachable.

4. The heat dissipation assisting apparatus for lamp as claimed in claim 3, wherein a plurality of extension members are disposed on an outer surface of the heat dissipation lamp holder.

5. The heat dissipation assisting apparatus for lamp as claimed in claim 1, wherein a transparent cover is disposed at the other side of the heat dissipation lamp holder to cover the light emitting module.

6. The heat dissipation assisting apparatus for lamp as claimed in claim 1, wherein the light emitting module comprises at least one light emitting diode (LED) chip.

7. The heat dissipation assisting apparatus for lamp as claimed in claim 1, wherein a gap distance between the heat dissipation lamp holder and the shell is 6 mm.
